(19) United States
(12) Patent Application Publication
(10) Pub. No.: US 2010/0146394 A1
(43) Pub. Date: Jun. 10, 2010

(54) Methods, Systems, And Computer Program Products For Browsing Using A Geospatial Map Metaphor

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/328,036

(22) Filed: Dec. 4, 2008

(51) Int. Cl. G06F 3/048

(52) U.S. Cl. 715/733

(57) ABSTRACT

Methods and systems are described for browsing using a geospatial map metaphor. In one aspect, input for indicating a content provider associated with a location on a map being presented via a user interface is received. A geospatial identifier associated with the content provider associated with the location on the map is determined. A network address for the content provider is determined based on the determined geospatial identifier. Content from the content provider is requested via the determined network address. Content from the content provider is received in response to the request.

### RELATED APPLICATIONS

This application is related to the following commonly owned U.S. patent applications, the entire disclosure of each being incorporated by reference herein:

Application Ser. No. 11/962,285 (Attorney Docket No I509/US) filed on Dec. 21, 2007, entitled “Methods and Systems for Sending Information to a Zone Included in an Internet Network”;

Application Ser. No. ______ (Attorney Docket No I516/US) filed on ______, entitled “Methods, Systems, and Computer Program Products for Accessing a Resource Based on Metadata Associated With a Location On A Map”;

Application Ser. No. 12/170,281 (Attorney Docket No I522/US) filed on ______, entitled “Methods and Systems for Resolving a Geospatial Query Region to a Network Identifier”;

Application Ser. No. 12/170,829 (Attorney Docket No I523/US) filed on ______, entitled “Methods and Systems for Resolving Location Information to a Network Identifier”;

Application Ser. No. 12/170,833 (Attorney Docket No I524/US) filed on ______, entitled “Methods and Systems for Resolving a Query Region to a Network Identifier”;

Application Ser. No. ______ (Attorney Docket No I527/US) filed on ______, entitled “------.”

Application Ser. No. ______ (Attorney Docket No I508/US) filed on ______, entitled “Methods, Systems, and Computer Program Products for Associating Resources of a First Geospace with a Second Geospace”;

Application Ser. No. ______ (Attorney Docket No I515/US) filed on ______, entitled “Methods, Systems, and Computer Program Products for Resolving a Network Identifier Based on a Geospatial Domain Space Harmonized with a Non-Geospatial Domain Space”; and

Application Ser. No. ______ (Attorney Docket No I534/US) filed on ______, entitled “Methods, Systems, and Computer Program Products for Accessing a Resource Having a Network Address Associated with a Location on a Map.”

### BACKGROUND

Current web browsers do not provide a user with a sense of location for easing navigation and for knowing a location of a resource browsed. Browsers take users from one page to another with no transition that relates the two pages. Some pages provide information that relates them to other pages using, for example, links labeled “back” and “next. This provides a sense of location only within a select group of web pages.

Having sense of “where you are” on the web would raise the comfort level of many users and ease navigation for others. Accordingly, there exists a need for methods, systems, and computer program products for browsing using a geospatial map metaphor.

### SUMMARY

Methods and systems are described for browsing using a geospatial map metaphor. In one aspect, input for indicating a content provider associated with a location on a map being presented via a user interface is received. A geospatial identifier associated with the content provider associated with the location on the map is determined. A network address for the content provider is determined based on the determined geospatial identifier. Content from the content provider is requested via the determined network address. Content from the content provider is received in response to the request.

In another aspect, a system for browsing using a geospatial map metaphor includes means for receiving input for indicating a content provider associated with a location on a map being presented via a user interface; means for determining a geospatial identifier associated with the content provider associated with the location on the map; means for determining a network address for the content provider based on the determined geospatial identifier; means for requesting content from the content provider via the determined network address; and means for receiving content from the content provider in response to the request.

In another aspect, a system for browsing using a geospatial map metaphor, includes an input router component configured to receive input for indicating a content provider associated with a location on a map being presented via a user interface; a navigation space handler component configured to determine a geospatial identifier associated with the content provider associated with the location on the map; a geospatial identifier resolver component configured to determine a network address for the content provider based on the determined geospatial identifier; a content manager component configured to request content from the content provider via the determined network address; and a content handler component configured to receive content from the content provider in response to the request.

In another aspect, a computer readable medium embodying a computer program, executable by a machine, for browsing using a geospatial map metaphor is described. The computer program includes executable instructions for receiving input for indicating a content provider associated with a location on a map being presented via a user interface; determining a geospatial identifier associated with the content provider associated with the location on the map; determining a network address for the content provider based on the determined geospatial identifier; requesting content from the content provider via the determined network address; and receiving content from the content provider in response to the request.

### BRIEF DESCRIPTION OF THE DRAWINGS

Advantages of the subject matter described will become apparent to those skilled in the art upon reading this description in conjunction with the accompanying drawings, in which like reference numerals have been used to designate like or analogous elements, and in which:

FIG. 1 is a flow diagram illustrating a method for browsing using a geospatial map metaphor according to an aspect of the subject matter described herein;

FIG. 2 is block a diagram illustrating a system for browsing using a geospatial map metaphor according to another aspect of the subject matter described herein;

FIG. 3 is a block diagram illustrating an arrangement that includes selected execution environment components of a device for hosting a system for browsing using a geospatial map metaphor according to yet another exemplary aspect of the subject matter described herein; and

FIGS. 4A, 4B, and 4C are diagrams illustrating user interfaces with maps positioned in presentation spaces.

### DETAILED DESCRIPTION

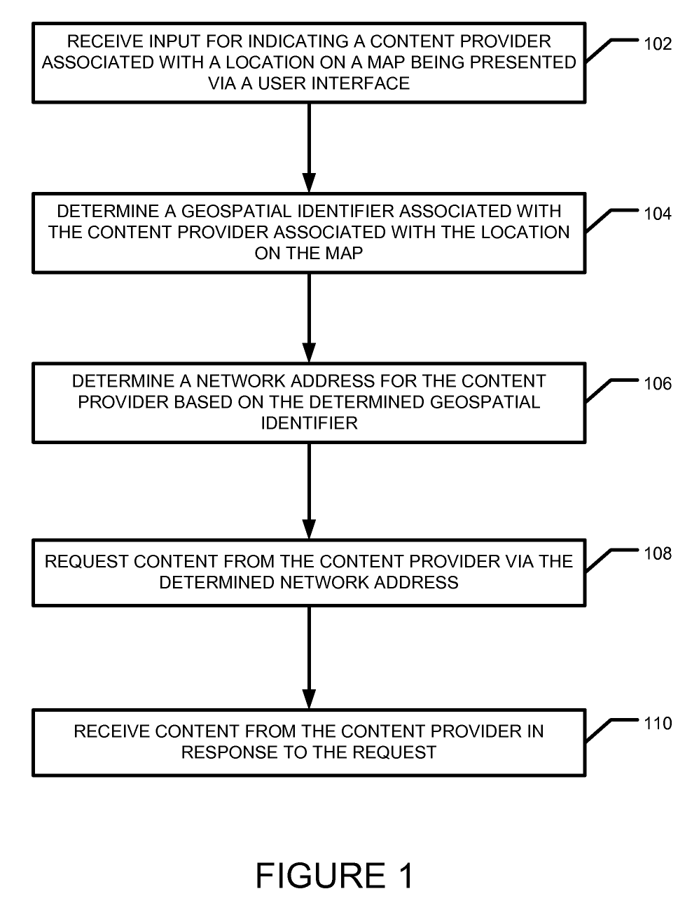

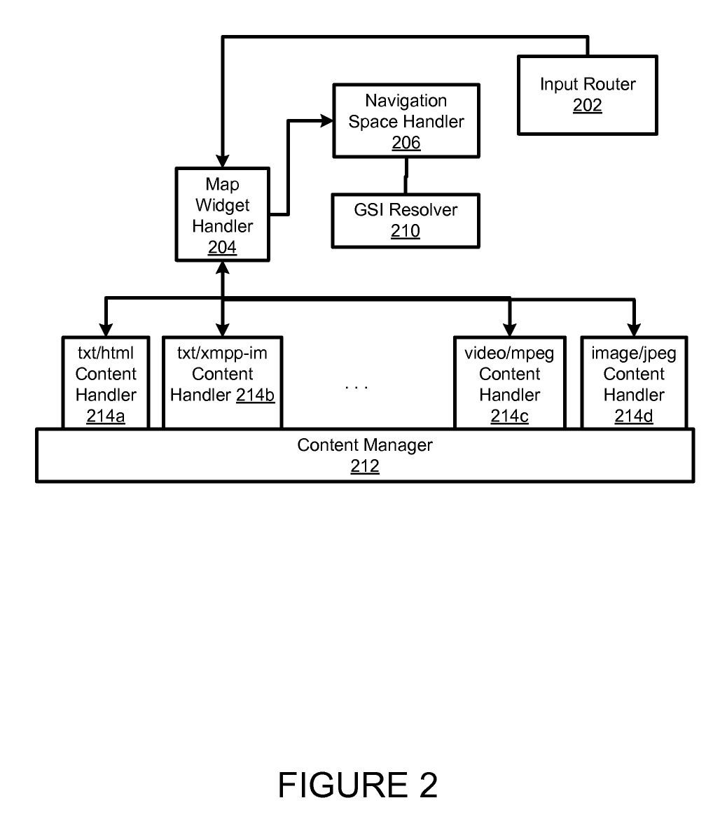

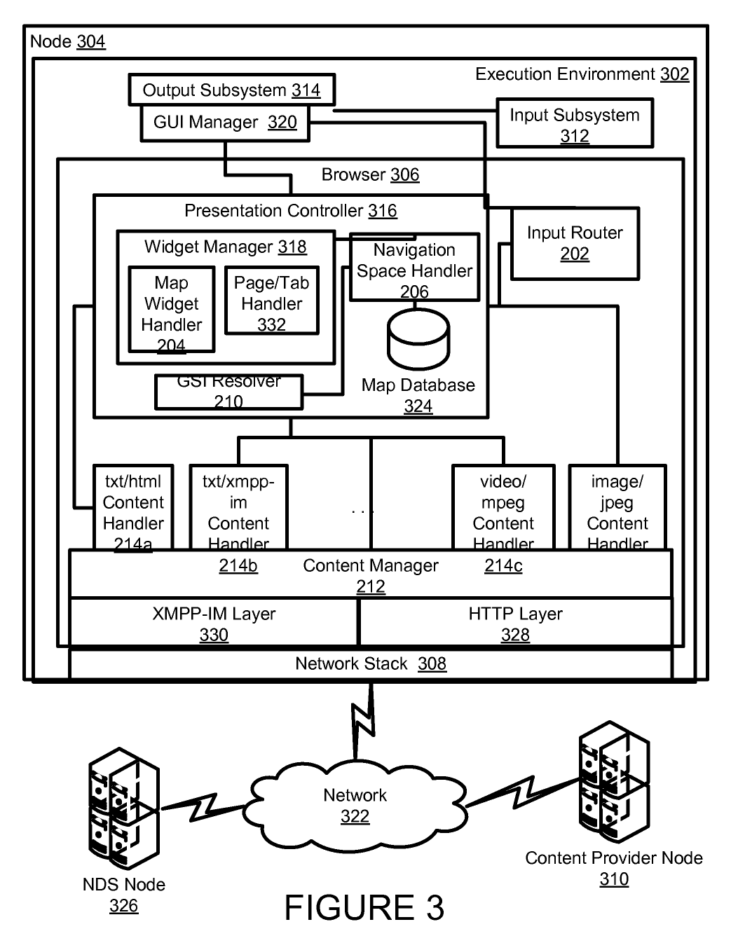

FIG. 1 is a flow diagram illustrating a method for browsing using a geospatial map metaphor according to an exemplary aspect of the subject matter described herein. FIG. 2 is a block diagram illustrating an arrangement of components for browsing using a geospatial map metaphor according to another exemplary aspect of the subject matter described herein. FIG. 3 is a block diagram illustrating an arrangement of selected components included in an execution environment provided by a device configured for hosting the arrangement of components illustrated in FIG. 2. Accordingly, the method illustrated in FIG. 1 can be carried out by, for example, some or all of the components illustrated in FIG. 2 operating in a compatible execution environment, such as the execution environment illustrated in FIG. 3.

In FIG. 3, an execution environment 302 is provided by a node 304 for hosting a browser 306. A node is a device with a network interface, such as an Ethernet network interface card (NIC) and/or wireless adapter, configured to interoperate with a network. Any execution environment 302 capable of hosting a browser 306 that is configured to perform the methods described in this document is within the scope of the systems and methods described. A typical execution environment can include a memory for storing instructions and data, a processor for processing the instructions and data, a control program or operating system for managing the memory and processor making the instructions and data accessible to the processor. An operating system, persistent data storage subsystem, memory management subsystem, and a process scheduler are examples of components that can be required for various execution environments. The execution environment 302 can include other subsystems or components as required by the components illustrated in FIG. 2 for any particular configuration. For example, a network subsystem, such as a network stack 308 in FIG. 3, can be included in the execution environment 302 for communicating with a component in a remote device, such as a content provider node 310 as described below. The exemplary execution environment 302, illustrated in FIG. 3, includes a processor (not shown); a processor memory (not shown), such as random access memory (RAM); a control program (not shown), such as an operating system for coordinating and managing the resources of the execution environment 302; a network subsystem that includes the network stack 308; an input subsystem 312; an output subsystem 314; and a persistent memory (not shown), such as a disk drive under the control of a storage subsystem supporting, for example, a database and/or a file system.

Exemplary nodes that can provide compatible execution environments include desktop computers, notebook computers, servers, mobile devices such as mobile phones, media capture and recording devices, personal digital assistants (PDA), and media players, including handheld, portable, and stationary media players.

In FIG. 3, a presentation controller 316 is configured to present a map in a presentation space associated with a presentation coordinate space for positioning content for presentation in a corresponding user interface (UI) widget. As used herein, the term “content” may be defined as data provided for presentation by a network-accessible service operating in a node. Examples of content include web pages from web application servers, media streams from media services, notifications from subscription services, a list of files from a file server, and error or other response codes.

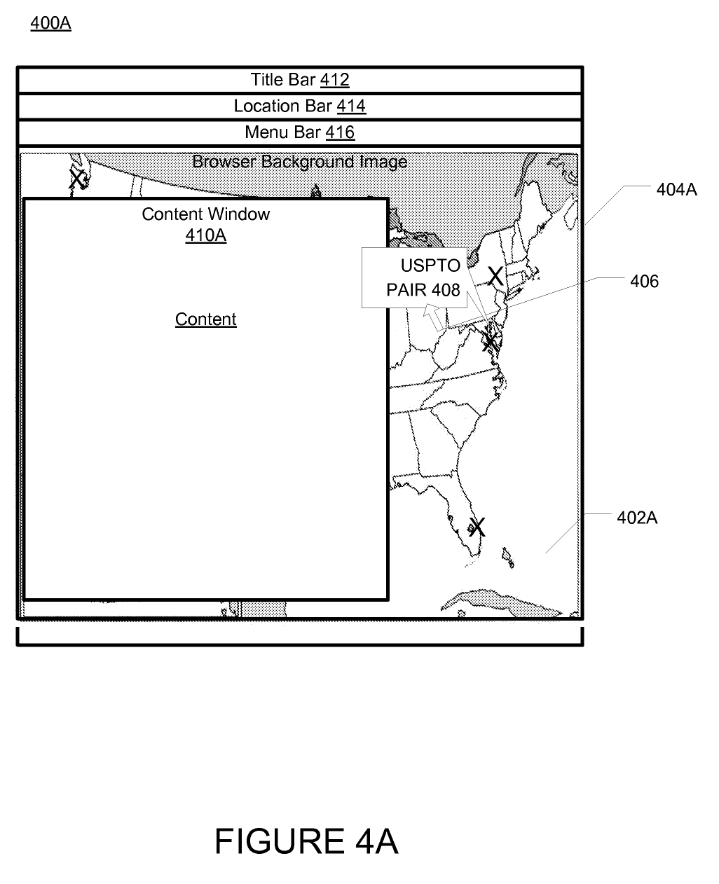

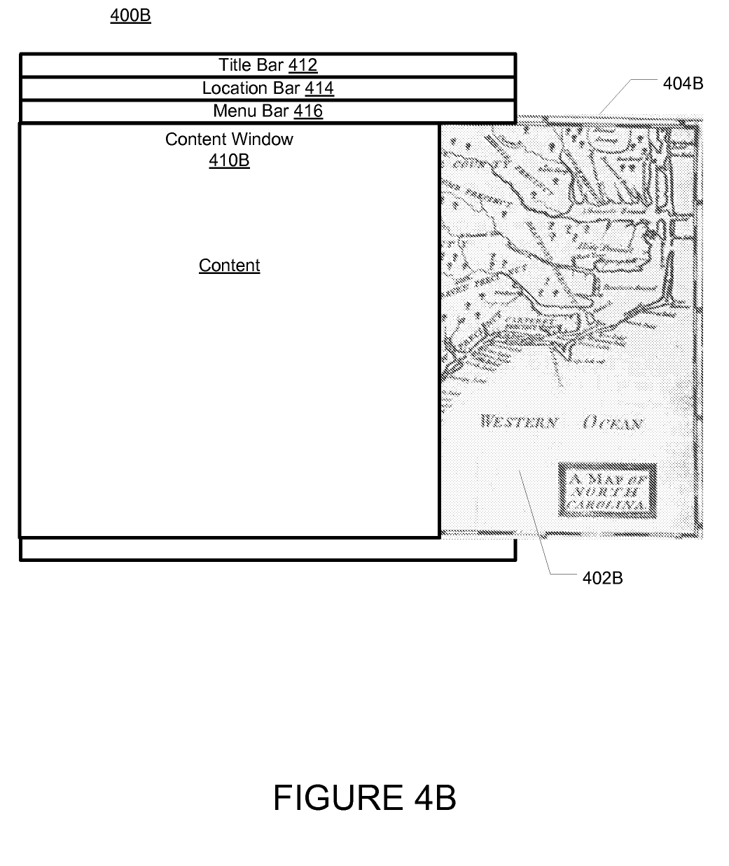

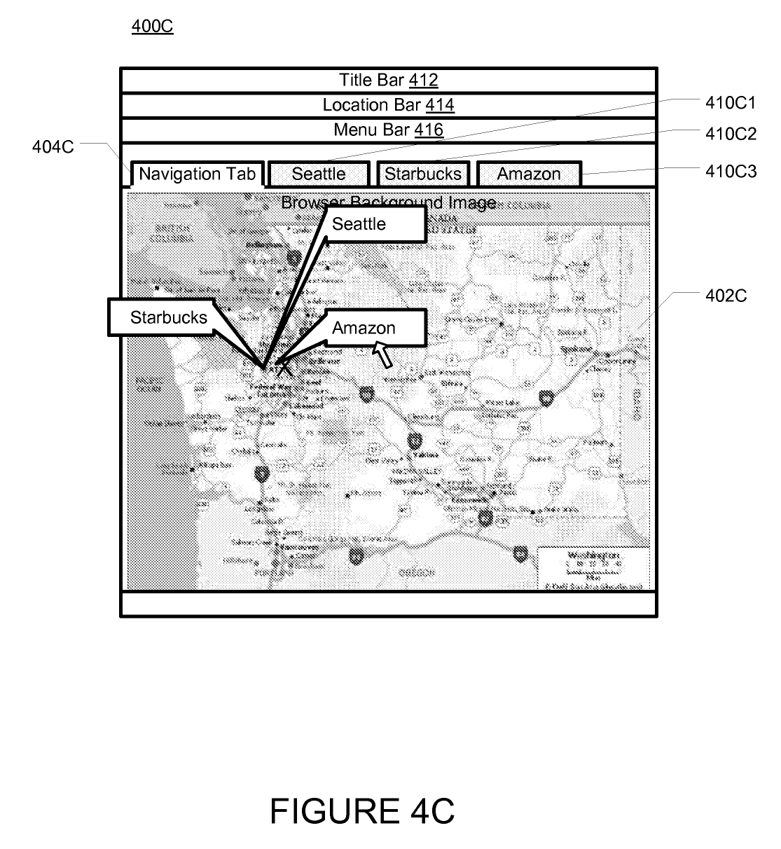

With reference also to FIGS. 4A-C, user interfaces 400A-C are depicted with maps 402A-C positioned in presentation spaces of map UI widgets 404A-C, respectively. As used herein, the term “map” may be defined as a visual representation of a space that typically has 2 or 3 dimensions, but maps of spaces of other dimensions are also within the scope of this document. Each region of a map is associated with a corresponding region of a space that the map represents. A map can represent a real space, such as North America, the Earth or another celestial object, a man made space, such as a building, or a park. A map can represent a virtual space such as a virtual world. In fact, a virtual space can be a map corresponding to a real space. Thus, there can be maps of maps. The use of maps associated with spaces with geographic attributes is described herein. Such spaces are referred to as geospaces herein.

Returning to FIG. 3, a map widget handler component 204 can be instantiated by a widget manager 318 included in the presentation controller 316. The map widget handler component 204 can be configured to draw a map to a presentation space of a widget for positioning a map 402A-C using a presentation address space. The presentation address space can be a coordinate space including a set of integer pairs (x, y) indicating, for example, a location x pixels in a horizontal direction and y pixels in a vertical direction from a specified base point. The upper left corner of the presentation space can be assigned the coordinate (0, 0) for use as a reference point. The map position can be provided as input data to the map widget handler component 204 and/or can be provided dynamically for repositioning the map. The map widget handler component 204 can be configured to invoke a navigation space handler component 206. The invocation can include providing presentation address space information to the navigation space handler component 206.

The navigation space handler component 206 can be configured to transform an address of a location in a region represented by the map to a presentation space address of a corresponding location in a region of a presentation space. Alternatively, the map widget handler component 204 can perform the transformation to the presentation space address when provided with address space information of locations on the map. The map widget handler component 204 can transform addresses for a region in the map to presentation space addresses to draw a representation of the region in the map in the presentation space.

As used herein, the term “geoaddress” may be defined as an address for identifying a region and/or regions in a “geospace.” A geospace can be divided into one or more regions. A map of a geospace can include representations of the regions of the geospace. A region has a size that can be as large as the geospace in which it is included. A region of a geospace and a corresponding map can be associated with an address that uniquely identifies the region in the context of the geospace represented and the map.

A set of addresses that correspond to locations in a geospace and/or a corresponding map representation of the geospace is called an address space. For example, the surface of the Earth, in whole and in part, has been and is represented by various types of 2-dimensional and 3-dimensional maps. Some maps use a grid system where each grid is identified by a tuple of coordinates. For example, a coordinate pair can be used where one coordinate identifies a region in a horizontal orientation and the other coordinate identifies a region in a vertical orientation. The coordinate pair together identifies a region defined by the intersection of the horizontal region and the vertical region. Several forms of global positioning system (GPS) coordinate spaces are currently in use including a degrees/minutes/seconds address space, a degree decimal minutes address space, and a Universal Transverse Mercator (UTM) address space. An address space associated with a map/space does not have to be coordinate-based. Any address space that includes addresses for identifying regions in the space and represented by an associated map is within the scope of this document. For example, USA, NC, Cary, 100 Main St, Suite 100 can be an address identifying a business work site in the space occupied by the Earth and can be associated with a map of the Earth for identifying a region included in the map corresponding to a region on the surface of the Earth. An address space for identifying a region and/or regions in a geospace is also referred to as a geoaddress space and an address from a geoaddress space is also referred to as a geoaddress herein. The terms region and location are used interchangeably herein.

A transformation operation can be performed by at least one of the map widget handler component 204 and the navigation space handler component 206 for transforming a geoaddress to a presentation space address. There are a number of suitable mechanisms. The mechanism selected can depend on characteristics of a map, a presentation space, their relationship, and/or developer decisions. Some transformations can be performed by applying a particular formula to a geoaddress to yield a corresponding presentation address, such as a coordinate pair. In at least one instance, a geoaddress space associated with a map can have a direct transformation to a presentation address space. The geoaddress space and the presentation address space can be identical or differ only in scale. Other transformations can include a function that shrinks and/or stretches a region of a map for drawing to a corresponding region of a presentation space based on the transformation of geoaddresses to presentation addresses. Some transformations can be performed by at least one of the map widget handler component 204 and the navigation space handler component 206 using a transform table. Given a geoaddress, a lookup can be performed on a transform table to determine an entry with an index that meets a specified matching condition associated with the transform table or with the entry. A matching entry can contain a presentation address that completes the transformation. Alternatively, a matching entry in a transform table can include a function or other executable code that can be processed with a geoaddress or geoaddresses as input to generate a presentation address or addresses for transforming a map location to a presentation space location.

In some arrangements, for a specified map, a transformation function and/or lookup table is known, for example via configuration. The configuration can be provided to at least one of the map widget handler component 204 and the navigation space handler component 206 prior to presentation of a map. In other cases, the navigation handler component 206 and/or the map widget handler component 204 can be configured to determine a transformation function and/or to generate a transform table for transforming, for example, a geoaddress space of a map 402 or a portion thereof to an address space of a presentation space for presenting the map 402.

Transformation operations that perform a function and/or perform a lookup in a table for transforming a first address from a first address space of a first space to a second address of a second address space of a second space are well known to those skilled in the arts of mathematics, and particularly in geometry and topology. Cartographers, for example, are familiar with transforming addresses from the 3-dimensional address spaces corresponding to a globe and/or the earth to a 2-dimensional address space for presenting a 3-dimensional map or model in a 2-dimensional presentation space such as a paper map.

The mapping between an address space of a presentation space and a geoaddress space of a map can be one-to-one, but need not be since a mapping in some arrangements need only identify a region associated with a content provider. As used herein, the term “content provider” may be defined as any entity, operating in an execution environment of a node, configured to provide data for presentation to a remote node via a network. A node is a device operatively coupled to a network. The term content is used to refer to both the data and presentable representations (e.g. a presentation on a display) of the data in this document. The context in which the term appears should be used to determine whether data, presentation, or both are intended.

Thus, a mapping that identifies any location in the region can be sufficient to identify a location associated with the content provider. For example, in a map where the associations of content provider locations on the map are sparse with respect to the geoaddress space, a transform function that is one-to-one is not necessary. In another example, an address space of a presentation space can be denser than a geoaddress space of a map. The precision of identifiers used for an address space and a geoaddress space affects the selection and/or determination of transform functions as well, as will be evident to those skilled in the art.

The map widget handler component 204 can be configured to present the corresponding map UI widget 402 by invoking a GUI manager 320 operatively coupled to an output subsystem 314. The GUI manager 320 can be configured to provide content and drawing instructions to the output subsystem 314. The output subsystem 314 can be operatively coupled to an output device such as a display (not shown). The output subsystem 314 can be configured to cause a representation of the user interface 400, including the map UI widget 404A-C and the map 402A-C, to be presented on an output device when directed, for example, by components of the presentation controller 316 as described above.

With reference to FIG. 1, in block 102 input is received for indicating a content provider associated with a location on a map being presented via a user interface. Accordingly, a system for browsing using a geospatial map metaphor includes means for receiving input for indicating a content provider associated with a location on a map being presented via a user interface. For example, as illustrated in FIGS. 2 and 3, an input router component 202 is configured to receive input for indicating a content provider associated with a location on a map being presented via the user interface 400.

The input router component 202 in FIG. 2 can be configured to receive input for indicating a content provider corresponding to a location on a presented map. The map is presented in a presentation space storing a representation of the map for presenting and having a location corresponding to the presented location corresponding to the input received.

In one aspect, a map is presented in a presentation space of a browser and the input for indicating the content provider is received via the input subsystem in correspondence with the presented map in the browser presentation space. In FIG. 3, the input router component 202 is adapted for operation in the browser 306 along with the remaining components in FIG. 2. The map widget handler component 204 can be configured to present a map, such as maps 402, in a presentation space of a widget, such as map widgets 404 illustrated in FIG. 4A, FIG. 4B, and FIG. 4C, respectively. The input router component 202, in FIG. 3, receives an input for indicating a content provider corresponding to a location on the presented map. The location and the input indicator can be associated based on the input event type and its interpretation. For example, each user interface 400A-C in FIGS. 4A-C depicts an exemplary map 402A-C, respectively, presented by the browser 306, where each map 402A-C includes a presented location associated with content provider operating in a content provider node 310 on a network 322. That is, each map 402A-C provides a metaphor or representation for navigating and browsing the Internet and/or other network. In each UI 400A-C presenting each respective map 402A-C, an input indicator can be received via an input device (not shown) by the input subsystem 312 included in the execution environment 302 of the node 304.

The input subsystem 312 can provide the input indicator to the GUI manager 320. The GUI manager 320 can be configured to determine an input handler based on a state of the presented user interface associated with the received input. For example, when the input is a mouse click indicator from a mouse device, the GUI manager 320 can be configured to determine a location in a presentation space of the display of a pointer icon corresponding to the received input indicator. Based on the determined location, the GUI manager 320 can determine an application by determining a region associated with the application including the determined location. In some arrangements, the GUI manager 320 can be configured to determine a UI widget visible in a region that includes the determined location corresponding to the received input.

In one aspect, input is received indicating user selection of a presented map mark providing a visual indication of a content provider having a geospatial identifier associated with the location on the map. For example, the input router component 202 can be configured to receive input for indicating a content provider associated with a location on the map 402A-C being presented via a user interface 400A-C by receiving input indicating user selection of a presented visual indication of a content provider having a geospatial identifier associated with the location on the map. As used herein, the term “geospatial identifier” may be defined as any identifier that includes at least a portion that is based on a geoaddress usable for identifying a region of a geospace associated with a geoaddress space that includes the geoaddress. Examples of geospatial identifiers include:

“postal://usa.nc.cary.main-street:100.suite:100.placid”

“postal://placid.suite:100.main-street:100.cary.nc.usa” (in reverse format)

“postal://placid.suite:100:main-street:100.27518” (shortened using a zip code)

Each of the three examples is based on a US Post Office geoaddress space that includes postal addresses.

Three examples of geoaddresses each from a different geoaddress space specifying the same region, location A, on the Earth are shown below. The first geoaddress is from the World Geographic System (WGS) geoaddress space. The second geoaddress is from the commonly known latitude/longitude geoaddress space for addressing Earth locations. Each of the latitude and longitude coordinates can be expressed in degrees, minutes, and/or seconds. The third geoaddress is from the GPS geoaddress space.

WGS: 30.29128 Latitude, −97.73858 Longitude

Deg/Min/Sec: 30°17′28″ Latitude, −97°44′18″ Longitude

GPS: N30 17.477 Latitude, W97 44.315 Longitude

In FIG. 4A, an arrow icon 406 is presented as a visual indicator over a user interface control referred to as a map mark 408. The arrow icon 406 and the map mark 408 are presented in the presentation space of a map UI widget 404A along with the map 402A.

In the arrangement 300, the GUI manager 320 can invoke the input router component 202 of the browser 306 based on the association of the region on the display where map UI widget 404A is visible and its association with the browser 306. The input router component 202 can be specified to the GUI manager 320 as the input routing interface for the browser 306 during interoperation with the GUI manager 320, for example, during initial setup and/or during the instantiation of the map widget handler component 204.

The input indicator can be generated by a variety of input mechanisms (not shown) such as a soft control (e.g., menu item or button) and/or hard control (e.g., mouse key or control on keypad key). The GUI manager 320 can provide input information based on the received input indicator to the input router component 202 that can be configured to route the input information to the map widget handler component 204 as described below.

In an alternative arrangement, the GUI manager 320 can be configured to invoke the map widget handler component 204 directly or via the widget manager 318. Interaction between an application and its components with a GUI manager 320 depends of the design of the GUI manager 320 and interfaces provided by the GUI manager 320, as is known to those skilled in the art of graphical user interface programming.

In another aspect, the input router component 202 can provide the input information to the navigation space handler component 206. For example, the input router component 202 can be configured to provide input information to the presentation controller 316. The presentation controller 316 can use the input information to present visual and/or audio feedback in response to the input including a visual representation on the presentation of the map 402A-C. The map widget handler component 204 directed by the presentation controller 316 can identify the map widget 404A-C and provide instructions to the GUI manager 320 to present the feedback on a presentation device via the output subsystem 314. Alternatively, the presentation controller 316 can interoperate with the GUI manager 320 to direct the presentation of feedback associated with the input indication.

Input received can be associated with a location on a map where there is no visual indication of a content provider or with a location on a map where there is a visual indication of a content provider, such as the map mark 408. A map mark, such as the map mark 408, provides a visual indication of a content provider at a location on a map 402A-C as configured by, for example, a user, imported from a map mark configuration store, and/or as configured by a provider of a browser. A map mark can include and/or reference a uniform resource identifier (URI), such as a uniform resource locator (URL), a network address, a geospatial identifier associated with a location on the map with which a corresponding visual indicator is associated, and/or a geoaddress identifying the location associated with the map mark 408 on the map 402A-C. A URI, network address, or a geospatial identifier included and/or referenced in/by a map mark 408 can be determined given the geoaddress of the location on the map associated with the content provider, as described below.

A network identifier is a logical identifier for a communication endpoint on a network. A network identifier can be at least one of a network address and a symbolic identifier of a network address, such as a DNS name. A network address is a network layer address identifier for a network interface (e.g. unicast) or a set of interfaces (e.g. multicast or broadcast).. Internet protocol (IP) addresses are commonly known network addresses for communicating over IP networks and internets. A network address known as a broadcast address can identify a type or class of communication node. A network address that identifies a single communication node is referred to as a unicast address. The term network address in this document refers to a unicast network address unless explicitly indicated otherwise. Example networks each supporting its own network address format include IP networks, internetwork packet exchange (IPX) networks, NetBIOS networks, and asynchronous transfer mode (ATM) networks.

The browser 306 can be configured to present a single map or a plurality of maps either serially and/or in parallel. Map information for presenting a map 402A-C can be included in the instructions of a map drawing executable. Alternatively, map information for presenting a map 402A-C can be stored in a data store that can be provided locally by the execution environment 302 of the node 304, such as a map database 324 included in the browser 306 illustrated in FIG. 3. Alternatively, map information can be accessible via a data store external to a browser. For example, map information can be stored in one or more remote data stores accessible to the browser 306 via the network 322.

The map presented via the user interface can represent a geographic region, a man made structure, a man-made geospace (i.e., a geospace including a man-made geographic attribute), a virtual geographic region, a virtual structure, and/or a virtual geospace. Each map can have a geoaddress space including a geoaddress for identifying a location on the map associated with a content provider such as a content provider. A map location is identified by at least a portion of a geoaddress in a geoaddress space associated with the map and the geospace represented by the map

A geoaddress space can be of any form and format suitable for identifying locations and regions of a map. For example, a map of the earth can be associated with an address space including identifiers specified as global positioning satellite (GPS) coordinates. Indeed, those skilled in this art will appreciate that there is more than one geoaddress space currently in use for specifying GPS coordinates (i.e., GPS geoaddresses). A map of a geospace can use a simple coordinate tuple such as an (x, y) pair commonly known as Cartesian coordinates for a 2-dimensional space or the tuple may represent the real and imaginary parts of a complex number. Geospaces with more than 2 dimensions can be presented and can be associated with a geoaddress space for identifying locations in the geospace. The dimensions in a multi-dimensional geospace need not be orthogonal nor does each dimension have to be flat. Maps and corresponding geoaddress spaces including geoaddresses for identifying locations in curved geospaces are within the scope of the methods and systems described in this document.

Returning to FIG. 1, in block 104 a geospatial identifier associated with the content provider associated with the location on the map is determined. Accordingly, a system for browsing using a geospatial map metaphor includes means for determining a geospatial identifier associated with the content provider associated with the location on the map. For example, as illustrated in FIGS. 2 and 3, the navigation space handler component 206 is configured to determine a geospatial identifier associated with the content provider associated with the location on the map.

In an aspect, a geospatial identifier associated with the content provider associated with the location on the map is determined by determining a geoaddress of the content provider based on a location corresponding to the content provider on a map. For example, the navigation space handler component 206 can be configured to determine a geospatial identifier associated with the content provider associated with the location on the map by determining a geoaddress based on the location on the map 402A-C. A navigation space handler component 206 can be configured to determine the geoaddress based on a presentation space address in a presentation space of a representation of the location corresponding to the content provider in a presentation of a map.

The input router component 202, as illustrated in FIG. 3, can be configured to route the input information within the browser 306 based on, for example, a widget identifier included in or determined from the input information. For example, the input information can include a widget identifier of the map widget handler component 204. The input information can be passed to the map widget handler component 204 included in the widget manager 318. The input information can include an input type indicator, such as “select” or “left-click” and a presentation space address such as a coordinate for identifying a location in the presentation space of the map widget 404A associated with the input information. The map widget handler component 204 can determine a location on the map 402A associated with the received presentation coordinate based on an inverse operation of the transformation of a geoaddress to the presentation coordinate. The inverse transformation can be performed in a manner analogous to the transformation of geoaddresses to presentation addresses described above.

In another aspect, a geospatial identifier associated with the content provider associated with the location on the map is determined by at least one of retrieving the geospatial identifier from a datastore associating geospatial identifiers with locations on the map and calculating the geospatial identifier from the location on the map. For example, the navigation space handler component 206 can be configured to determine a geospatial identifier associated with the content provider associated with the location on the map 402A-C by at least one of retrieving the geospatial identifier from a database 324 associating geospatial identifiers with locations on the map and calculating the geospatial identifier from the location on the map 402A-C. An inverse function and/or lookup table can be provided with a map and/or generated by at least one of the map widget handler component 204 and the navigation space handler component 206. Those skilled in the art of mathematics are familiar with techniques for determining whether a function has an inverse and determining the inverse. Similarly, the generation of inverse lookup tables is known. A geoaddress space and a presentation coordinate space lookup table can be generated that meet the requirements of a browser under particular conditions such as a map that is sparsely populated with content providers.

When a geoaddress has been determined for the location as described above, the geoaddress in the arrangement 300 can be provided to the navigation space handler component 206 by the map widget handler component 204 for determining a geospatial identifier associated with the location. When a browser 306 supports more than one active map, a map identifier can also be provided to the navigation space handler component 206 along with the geoaddress.

The navigation space handler component 206 determines a geospatial identifier based on the geoaddress associated with the received presentation space address. A geoaddress is one form of geospatial identifier as indicated above. In some arrangements, the determined geoaddress is sufficient information for determining a network address for the content provider, as is described below. In a typical arrangement, a geoaddress may not provide sufficient information for determining a network address of the content provider. A geoaddress can be a network address, such as geospatial IP address supported in IPv6. Alternatively or additionally, the determined geoaddress can identify a region associated with more than one content provider. In fact, a node can host multiple content providers that each use a different network address and/or share a network address. For arrangements of this type, the navigation space handler component 206 can be configured to determine a geospatial identifier based on a geoaddress and additional information.

For example, in an aspect, a geospatial identifier associated with the content provider associated with the location on the map is determined by determining the geospatial identifier based on the geoaddress and optional additional information, such as metadata associated with the location on the map 402A-C. For example, the navigation space handler component 206 can be configured to determine a geospatial identifier associated with the content provider associated with the location on the map 402A-C by determining the geospatial identifier based on the geoaddress and metadata associated with the location on the map 402A-C.

That is, optional additional information used by the navigation space handler component 206 to determine the geospatial identifier based on the geoaddress can be metadata associated with the location identified by the geoaddress. Above-identified U.S. patent application Ser. No. ______ (Attorney Docket No I516/US) describes methods and systems for providing metadata associated with a location on a map. Various types and formats of geospatial identifiers can be determined depending on the metadata provided and the configuration of the browser 306.

A visual indication of metadata associated with a location can be presented in any number of visual, audio, and/or tactile formats. Metadata can be provided and stored in any number of protocol and/or storage formats. Map mark 408 in FIG. 4A is an example of a visual indication of metadata associated with a location on a map.

In another aspect, the metadata indicates at least one of a service type associated with the content provider, at least a portion of a URI associated with the content provider, and a region of a geospace. In addition, the at least a portion of a URI indicated by the metadata can be determined based on at least one of a default value, a task that is being performed, the particular map, an active keyword associated with the map, a filter associated with the map, and a search specification associated with the map. For example, a map mark can be associated with a location on a map as described above. A map mark or other metadata entity can include a geospatial identifier associated with the location on the map. For example, a map mark can include a URI, such as the URL illustrated below:

“httpdms://www.30.17.28.-97.44.18/default.html”

In the example, the scheme “httpdms” in the URI indicates that the application protocol is http and also identifies a service, in this case a web server. The “dms” portion of the scheme indicates that the host name, www.30.17.28-97.44.18, portion of URI includes location information in latitude and longitude expressed in degrees, minutes, and seconds. The “www” prefix is a name of a node in the region identified by the location information in the host name corresponding to the region of the earth identified by latitude 30° 17′ 28″ and longitude −97° 44′ 18″. The path “/default.html” identifies a particular resource. The URI can be provided by a user, saved from a previous presentation of the requested resource, and/or determined based on input associated with a location on a map corresponding to the geoaddress and metadata provided to and/or discovered by the browser 306 as described below. The URI illustrated is a geospatial identifier for accessing an http server with the name, “www” in the location identified in the geospatial identifier.

In another aspect, the map mark 408 can include information used with the location information to determine an associated geoaddress or other geospatial identifier. For example, a map mark 408 can include keyword-value pairs for scheme=xmpp−im and principal=“myService@subscription.com” that, with the geoaddress corresponding to a location on a map, can be considered a geospatial identifier. The geoaddress can be used, as is described below, to determine a network address for accessing a node hosting the service identified by the value of the scheme attribute that also identifies the application protocol for accessing the service. The value of the principal attribute identifies a resource managed by the service. Its use in accessing a content provider is described below.

A map mark can include other types of resource information for use with or for forming a portion of a geospatial identifier. Examples of resource information include 1) an indication of a service type such as a retail service, a search service, and a dictionary service; 2) a path portion of a URL of the content provider associated with the location as described above; 3) a node name portion of a network name such as “www” described above; and/or 4) a protocol indicator such as HTTP, SIP, and XMPP also described above. Above-identified U.S. patent application Ser. No. ______ (Attorney Docket No I527/US) describes methods and systems for locating a service in a specified region. Above-identified U.S. patent application Ser. No. ______ (Attorney Docket No I516/US) describes methods and systems for providing metadata associated with a location on a map and creating map marks.

As indicated above, at least a portion of resource information can be received from user input, imported from an external configuration store, received from a remote node, and/or gathered during browsing. In some arrangements, the browser can dynamically determine resource information associated with a location on a map. For example, a location on a map can be identified via an input indication as described above. The input information can be provided to the input router component 202 as described above. The input router component 202 can be configured to route an input for indicating a service is to be identified for a specified region to the navigation space handler component 206 or the map widget handler component 204 depending on the particular browser arrangement. A geoaddress can be determined as described above. In this type of query, the navigation space handler component 206 can determine a geospatial identifier based on the determined geoaddress and a service type indicator or alias. A service type indicator is a predefined identifier for identifying a particular service type. For example, “_http” is a predefined indicator for use in locating web services in a given domain name system (DNS) domain using a query to the DNS that queries SRV records. In some arrangements, more than one service alias can be provided to the navigation space handler component 206. When a service indicator is not provided, a default can be configured for use by the navigation space handler component 206 or a server processing the query can be configured with a default when no service indicator is received. For example, in one arrangement, receiving no service indicator indicates network identifiers for all services within a specified location are to be returned in response to a query. A description of an arrangement for determining a service associated with a location is provided below and is further detailed in above-identified U.S. patent application Ser. No. ______ (Attorney Docket No I527/US).

The navigation space handler component 206 can be configured to generate a URI for accessing a content provider when provided with metadata associated with a location. For example, metadata associated with a location can be stored in a format for including a URI scheme, such as HTTP; a resource identifier, such as a path “/getform?formid=3”; a node portion of a network name, such as placido; and a DNS domain, such as “postal”, for construction of a host name portion of the URI. For example, the navigation handler component 206 can be configured to translate a presentation addresses associated with a presented map and corresponding to a received input to a US Post Office geoaddress associated with the map. An input indicator translated by the navigation handler component 206 to 100 Main Street, 27518 can be combined with the exemplary metadata above to determine the geospatial identifier: “http://placido.main-street:100.27518.postal”.

Alternatively, a scheme portion can be determined by the navigation space handler component 206 based on a specified default, a task being performed, the particular map in use, and/or an active keyword, filter, and/or search specification associated with the map depending on the configuration of the navigation handler component 206. Those skilled in the art can appreciate that any metadata that can be included in a map mark can be included in metadata entities that can be associated with locations on a map for other purposes. For example, a history mark for indicating a content provider accessed in the past can be associated with a location on a map associated with the visited content provider. Other metadata entity types include search marks indicating content providers associated with a search query result, presence principal marks associated with locations of watched presence principals, brand name marks indicating and presenting a brand representation in association with locations of content providers associated with a particular brand, and marks categorized, for example, by business entity category (e.g., public, private, and/or government) or retail category (e.g., clothing, automobile, and/or hardware). The above-listed categories are intended to be exemplary and not exhaustive, as content providers can be categorized in numerous ways and these categories can have sub-categories. Thus, a map mark and other metadata entities in other visual and storage formats can be associated with an input received for indicating a content provider associated with a location on a map. Metadata that is included in a map mark can include a geospatial identifier determined as described above or can include information that can be processed by a navigation space handler component 206 configured for determining a geospatial identifier based on the metadata and associated location information.

Another form of metadata associated with a location on a map can be a regional identifier. For example, a geospace can be divided into a set of regions, where each region is associated with a separate naming domain. The regions can be hierarchical with subdomains, flat, or structured in any arrangement such that a regional name can be used with at least a portion of a geoaddress identifying a subregion to determine a unique identifier within the set of naming regions or domains. Each domain or subdomain associated with a region or subregion can be granted authority to allocate names from a namespace of its own choosing with a format of its choosing. Alternatively, a namespace and format can be selected for a particular region by the authority of an enclosing region. A navigation space handler component 206 can be configured to receive location information and determine one or more region identifiers that include the location identified by the location information. The navigation space handler component 206 can determine a geospatial identifier based on the region identifier associated with the location on the map where the location is associated with a content provider. For example, an input associated with a location on a presented map of Wake county North Carolina can be identified with an identifier, such as USA.NC.Wake, Wake.NC.US, or Country=USA;State=NC;County=Wake.

Alternatively, United States Post Office addresses define a geoaddress space and geoaddresses from this geoaddress space can be formatted in a number of ways as illustrated above and below. In an example, an input is detected corresponding to a location of a pointer on a display. The location is associated with a content provider. The input is received by the input subsystem 312 as, for example, an (x, y) coordinate pair of a presentation space in which the map is presented. The input subsystem 312 provides the input to the GUI manager 320. The GUI manager 320 determines that the map UI widget 404A-C has focus on the display and determines the (x, y) coordinate pair in the presentation space of the map 402A-C presented in the map UI widget 404A-C that correspond to the received input. Input information based on the determined information is provided to the input router component 202. The input router component 202 routes the input information to the presentation controller 316. The presentation controller 316 can determine based on the input information whether the information is associated with a widget handler, the map widget handler component 204, managed by the widget manager 318, and if so provides the information to the map widget handler component 204 for processing. The map widget handler component 204 invokes the navigation space handler component 206 and provides presentation space information including the coordinate pair corresponding to the input location and other information to the navigation space handler component 206, such as a map identifier. The navigation space handler component 206 maps the coordinate pair to a geoaddress. The geoaddress includes identifier(s) of the region(s) that include the locations indicated by the coordinate pairs of the presentation space. Thus, the geoaddress space can include US Postal addresses and/or portions of US Postal addresses. For example, 100 Main Street, Cary, N.C. 27518 can be determined by the navigation space handler component 206 configured to process a map of North Carolina with regions associated with metadata identifying at least a portion of a region corresponding to the State of NC, the zip code 27518, the city of Cary, the lot assigned the ID of 100 on the street Main Street. Note the region identifiers are not necessarily hierarchical. The location corresponding to the presentation space address can be in the intersection of multiple identified regions. Alternatively, a GPS geoaddress space can be used instead of a set of US postal addresses. Many alternative geoaddress spaces can be used, as will be appreciated by those skilled in the art.

As discussed above, a US postal address is a geospatial identifier from a geoaddress space specified by the US Post Office. A URI using an exemplary “postal” scheme and a geospatial identifier determined from the US postal address geospatial identifier is also a geospatial identifier. The portion, “usa.nc.cary.main-street:100.suite:100,” is a geospatial portion of an exemplary URI. Additional metadata associated with the location, such as in a map mark, can include a host identifier portion of the “postal” URI scheme and additional geospatial information. In the example, “suite:100” is additional geospatial information for indicating a third dimension of the geospace. This information can be metadata associated with the location or the map can be a 3-D map, where the input received corresponds to a location in the 3-D geospace for enabling the navigation space handler component 206 in the process of mapping the presentation address to a geoaddress to determine a portion of a geoaddress corresponding to the third dimension, such as “suite:100”. A host name, “plankton” can be included in the map mark 408 or other metadata entity associated with the input indication. Such an exemplary URI is illustrated below:

“postal://usa.nc.cary.main-street:100.suite:100.plankton”

Another exemplary, scheme and format for a URI associated with the determined geoaddress is illustrated in the following URL:

“http://placid.suite:100.main-street:100.27518.geo”

The “geo” domain can be reserved to indicate that the URL is a geospatial identifier. A path portion of a URL can be included in metadata associated with the location for determining a geospatial identifier, such a “myAlbums” for identifying a photo album service operating in an execution environment provided by the node “placid”. Thus, the navigation space handler component 206 configured to process URL path portions can generate the geospatial identifier,

“http://placid.suite:100.main-street:100.27518.geo/myAlbums”

Associations of metadata with a location on a map can be static and/or dynamic according to the configuration of the system. Metadata for an association can be provided by a variety of sources based on any condition or attribute accessible to the browser and/or the metadata provider. For example, information for creating, updating, and/or removing an association of metadata with a location on a map can be provided as configuration information for a browser 306. Pre-configured service identifiers described above can be received as input by a browser, for example, as category information or a search query. Additional examples of metadata providers allowed to create, update, and/or remove an association of metadata with a location on a map include a map provider, a task or workflow manager, a user such as an administrator, manager, or parent, and a content provider. The information can be provided and an association processed based on, for example, a source of currently active content, a task being performed, an owner of a node and/or network hosting a browser, and/or an identity of a user of the browser 306.

One skilled in the art will appreciate that there can be a variety of arrangements for providing and managing metadata associated with a map where the metadata is usable by a navigation space handler component 206 for determining a geospatial identifier associated with a location on a map associated with a content provider. The arrangements described herein are illustrative and not intended to be exhaustive.

While the determination of a geospatial identifier is performed by the navigation space handler component 206 configured to operate in the browser 306 in FIG. 3, the determination can be performed by a navigation space handler component component external to a browser operating in the same or a separate execution environment as the browser. For example, a proxy server (not shown) can host a component for performing this determination.

Returning to FIG. 1, in block 106 a network address for the content provider is determined based on the determined geospatial identifier. Accordingly, a system for browsing using a geospatial map metaphor includes means for determining a network address for the content provider based on the determined geospatial identifier. For example, as illustrated in FIG. 2, a geospatial identifier (GSI) resolver component 210 is configured to determine a network address for the content provider based on the determined geospatial identifier.

In an aspect, a network address for the content provider based on the determined geospatial identifier is determined by determining one of an Internet protocol network address, a geospatial network address, a geospatial outside scope address described below, and a non-geospatial outside scope address. For example, a geospatial identifier resolver component 210 can be configured to determine a network address for the content provider based on the determined geospatial identifier by determining one of an Internet protocol network address, a geospatial network address, a geospatial outside scope address, and a non-geospatial outside scope address.

The navigation handler component 206 can be configured to communicate the determined geospatial identifier to the GSI resolver component 210 configured to determine a network address for the content provider based on the determined geospatial identifier. The GSI resolver component 210 can be configured to determine a network address based on a geospatial identifier in a number of ways. A GSI resolver component 210 can be provided with a geospatial identifier determined by the navigation space handler component 206 in the form of a URI as described above. In an alternative arrangement, the GSI resolver component 210 can be configured to determine the URI when provided with a geoaddress (i.e., a geospatial identifier) determined by the navigation space handler component 206 and additional metadata required for determining the URI as described above. The GSI resolver component 210 can be configured to detect a hostname portion of a URI. For example, in the URL “http://placid.suite:main-street:100.27518.geo/myAlbums” example described above, “placid.suite:main-street:100.27518.geo” can be resolved to a network address by querying a network directory system (NDS) server, such as a DNS server, hosted by an NDS node 326 illustrated in FIG. 3. An NDS node 326 includes records, such as an A record in a DNS server, that associate a network node name with an IP address of a network interface of a node assigned the name and IP address. Alternatively, a query can include geospatial information from the geospatial identifier. The NDS node 326 can be configured to validate that the network name and/or its associated network address is associated with a node location that is included in or at least partially in a location identifiable based on the geospatial identifier. That is, the node associated with the network name can be at least partially in or otherwise associated with the region identified by the geospatial information from the geospatial identifier. If the network name to network address association is located by the NDS node 326 and the location information is validated, the NDS node 326 returns the network address associated with the node.

Alternatively, a GSI resolver component 210 can be configured to send a query to an NDS node 326 where the query includes a geospatial name including a geospatial portion such as “suite:100.main-street.27518” for resolving a geospatial location to a network identifier as described in above-identified U.S. patent application Ser. No. 12/170,281 (Attorney Docket No I522/US). The NDS in one arrangement including the NDS node 326 can locate a set of domains identified as having nodes with node regions at least partially present in the region identified by the location information in the query. The GSI resolver component 210 can be configured to search an NDS representing one or more of the identified domains for a network identifier of node having a node region at least partially present in the region identified by the query. The network identifier can be network address or a network identifier resolvable to a network address, such as DNS node name. Further, the queried NDS can be configured to locate a record associating a network identifier of a node associated with a node region at least partially present in the query region and matching other matching criteria included in the query. The queried NDS can return a network address of a matching node and/or return a network name that the GSI resolver component 210 can resolve to a network address as DNS clients currently resolve DNS network names to IP network addresses. Alternatively, the NDS service node 326 can return at least a set of network names and/or associated network addresses along with information allowing the GSI resolver component 210 to evaluate the returned data based on matching criteria not evaluated by the queried NDS. The matching criteria can be based on metadata associated with a location on a map associated with a content provider. When an NDS response includes a set of network names and/or associated network addresses, the GSI resolver component 210 can be configured to return the network address associated with the matching node or nodes to the navigation space handler component 206.

An NDS can be configured to support caching services, as the DNS does, and the hosting node 304 can be configured to maintain locally configured and/or cached NDS information, analogous to the HOSTS file in use for storing DNS network name to IP address associations. The nodes can be located in a region and/or authorized to represent or otherwise be associated with the identified region.

While a current DNS server can be configured to receive and process a GSI resolver component 210 query, the current DNS is not configured to locate records of nodes associated with a specified region. In the current DNS, location information is stored in LOC records, as described in RFC 1876. LOC records including a geospatial address included in a specified region are scattered in DNS nodes throughout the Internet. Methods and systems for configuring an NDS including the DNS to locate nodes associated with a specified region are described in above-identified U.S. application Ser. No. ______ (Attorney Docket No I527/US) and U.S. application Ser. No. 12/170,281 (Attorney Docket No I522/US). With such a system in place, a GSI resolver component 210 cooperating with a navigation space handler component 206 can be configured to provide a geospatial identifier in a query to a DNS. The geospatial identifier is associated with the location for which a network address is to be determined. The geospatial identifier and optional metadata provided in the query allows the NDS to identify a specific network address or network identifier resolvable to a network address. Alternatively, the NDS can identify more than one network address and/or network identifier resolvable to a network address. The NDS can be configured to return a set of network addresses and/or corresponding node names associated with a region identified by the geospatial information in the query. The GSI resolver component 210 in this configuration can use network interface name and/or other matching criteria to match one of the network names and/or network addresses returned in the NDS response.

Metadata such as a category identifier described above can be stored in an NDS node 326 that is authoritative for at least a portion of a specified region. For example, the current DNS supports service records SRV for locating a service in a particular DNS domain. However, DNS domains are not geospatially defined nor associated with any particular geospatial region. A service query or a category query that is analogous to an extended service query can be generated and sent by a suitably configured GSI resolver component 210 for receiving at least one of a network name and a network address of a node having a node region at least partially present in the region identified by the determined geospatial identifier.

In yet another configuration, the system supports geospatial network addresses. Geospatial network address formats have been proposed and a number of methods and systems for routing data based on geospatial information included in a network have also been proposed. An address space associated with a map can be an address space supported by a geospatial network address space, such as a GPS address space. The navigation space handler component 206 can be configured to map a presentation space address to a geoaddress in the geoaddress space. The navigation space handler component 206 can further be configured to provide the geoaddress to the GSI resolver component 210. The GSI resolver component 210 can be configured to convert the geoaddress format to a network address format for a geospatial portion of a network address. For example, an input indication for indicating content provider can be associated with a location on a map corresponding to the GPS coordinates (N30 17.477:W97 44.315) formatted as written. The GSI resolver component 210 can be configured to generate a geospatial portion of a network address formatted as latitude:longitude:nodeID, where the first four bytes are the latitude and the second four bytes correspond to the longitude and twenty-four bytes for a geospatial subdomain portion and/or a network interface identifier portion. The precision of each address portion can be predefined or indicated in information provided with the address. The first eight bytes of the network address generated is 002e0b05:0094afbb. The remainder of the address can be generated using metadata associated with the location as described above, such as node or category information associated with the location.

In an alternative embodiment, the geospatial portion of the address is used in an outside scope address format as described in above-identified U.S. patent application Ser. No. 11/962,285 (Attorney Docket No I509/US). A service or a node portion of a network identifier, for example, can be included in the message allowing a border node to identify a network address in a portion of the network served by the border node, such as a subnet, and identified based on the outside scope address. A message addressed using an outside scope network address can include a request for a service identifier. A border node can provide one or more network addresses for nodes providing the service and/or a border node can return an alias for sending data to the service when data is addressed using the outside scope address and the service ID. An outside scope address to determine a network address of a service in a portion of network can be used in a non-geospatial network such as the Internet, as described in above-identified U.S. patent application Ser. No. 11/962,285 (Attorney Docket No I509/US) and U.S. patent application Ser. No. 12/170,829 (Attorney Docket No I523/US).

Returning to FIG. 1, in block 108 content is requested from the content provider via the determined network address. Accordingly, a system for browsing using a geospatial map metaphor includes means for requesting content from the content provider via the determined network address. For example, as illustrated in FIGS. 2 and 3, a content manager component 212 is configured to request content from the content provider via the determined network address.

The network address or a portion thereof determined by the GSI resolver component 210 can be returned to the invoking map widget handler component 204 via the navigation handler component 206 in FIG. 2. The map widget handler component 204 can provide the network address to the content manager component 212 configured to send a message to the indicated content provider associated with the location or to a content handler 214 component configured to create and send the message to the indicated content provider via the content manager component 212.

The content provider can be a content provider such as a web server, for example, and/or a subscription service, such as a publish-subscribe service that can be a presence service. Accordingly, in an aspect, requesting content from the content provider via the determined network address and receiving content from the content provider in response to the request includes communicating with the content provider using a publish-subscribe protocol. For example, the content manager component 212 can be configured to request content from the content provider via the determined network address using a publish-subscribe protocol and the content handler component 212 can be configured to receive content from the content provider in response to the request by using a publish-subscribe protocol.

For example, a presence protocol is an exemplary publish-subscribe protocol. The architecture, models, and protocols associated with presence services in general are described in “Request for Comments” (or RFC) documents RFC 2778 to Day et al., titled “A Model for Presence and Instant Messaging” (February 2000), and RFC 2779 to Day et al., titled “Instant Messaging/Presence Protocol” (February 2000), each published and owned by the Internet Society. A presence protocol is a type of publish-subscribe protocol that can be additionally defined generally as having an additional requirement not necessarily required of a pub/sub protocol. The additional presence-specific requirement is that a presence tuple contain a status element indicating a presence status.

The message format and the network protocol used to send the message can be determined by a variety of factors including a URI associated with the location as metadata as described below, capabilities of the browser including an active search mode of a browser configured to support modal operation, an active keyword or search term associated with the presentation of the map, information provided by a network directory service lookup, browser configuration (e.g., default request can be configured to be an HTTP GET), and/or an input indication (e.g., single click is an HTTP request, double click is a Subscribe, Ctrl-click can be an HTTP Post or a publish-subscribe notify message).

For example, the browser 306 in FIG. 3 includes one or more content handlers 214a-d for processing content according to a MIME type of content that can be sent, received, presented, and/or otherwise processed by the browser 306. If the map is presented as a JPEG image, an image/jpeg content handler component 214d is invoked, as illustrated in FIG. 3, and provided with a determined network address, input information, and metadata associated with the location. In another example, when the input is associated with a visual representation of a map mark and the map mark is presented based on HTML processed by a text/html content handler component 214a, the map widget handler component 204 can similarly invoke the text/html content handler component 214a. Alternatively, a content handler component type can be determined based on metadata associated with the location. For example, a map mark can include information indicating that an instant message and/or a presence message is to be sent to an associated content provider. In this scenario, the map widget handler component 204 can be configured to invoke a text/xmpp-im content handler component 214b.

The content manager component 212, operating as illustrated in FIG. 3, can receive a request to generate a message, such as when invoked by a content handler 214 or, alternatively the map widget handler component 204, providing the network address and optionally input information and/or metadata associated with the location on the map associated with the content provider. In response, the content manager component 212 can be configured to generate a message based on the information provided in the invocation. When invoked by a content handler component 214 and provided a message along with a determined network address, the content manager component 212 is configured to transmit the message to a recipient via the determined network address as a destination address. The content manager component 212 can invoke a protocol layer for sending the message. The protocol layer invoked depends on information provided to the content manager component 212 for sending the message. The message itself can indicate a protocol. An HTTP message indicates an HTTP layer 328 is to be invoked for sending the HTTP message. Alternatively, the content manager component 212 can select a protocol layer for sending based on metadata associated with a selected location as illustrated in metadata examples described above. A MIME type of data included in a message can affect the selection of a protocol layer as well. In the browser 306, illustrated in FIG. 3, the content manager component 212 can be configured to detect the MIME type of an instant message and invoke an XMPP-IM protocol layer 330 for sending the instant message. An invoked protocol layer 328, 330 transmits the message to the network 322 for routing to the content provider node 310 associated with the indicated location on the map via the network stack 308. The network 322 routes the message based on the determined network address. As previously described, the message can be sent using, for example, an IP network address, a geospatial network address, or a geospatial or non-geospatial outside scope address.

Returning to FIG. 1, in block 110 content is received from the content provider in response to the request. Accordingly, a system for browsing using a geospatial map metaphor includes means for receiving content from the content provider in response to the request. For example, as illustrated in FIGS. 2 and 3, the content handler component 214 is configured to receive content from the content provider in response to the request.

As described, the components illustrated in FIG. 2 include a content handler component 214 for processing content from a content provider. The content can be received and processed for storing locally, presenting a visual representation, presenting an audio representation, and/or otherwise processed according to, for example, the message sent, the content, and/or a received message including the content.

As illustrated in FIG. 3, the content provider node 310 can be configured to send a response to the browser 306 using, for example, an IP network address, a geospatial network address, or a geospatial or non-geospatial outside scope address for the node 304. The message can be a response message to the message sent via the content manager 212 as described above. The response message can be transmitted over the network 322 to a network interface of the network stack 308. The network stack 308 can process headers and/or trailers associated with the response message according to the protocol layers included in the network stack 308. The message can be routed to an application protocol layer 328, 330 when the message format is detected to be compatible with a particular application layer. The application layer 328, 330 can interoperate with the content manger 212 to deliver the response. The content manager component 212 can be configured to detect or determines a content type associated with at least a portion of the response message. A content type can be specified as a MIME type. Based on the detected/determined content type a compatible content handler component 214a-d is invoked by the content manager component 212 for receiving and processing the content of the detected/determined content type.

For example, the content provider 310 can be a web site. The response to the message can include a web page generated using HTML. The response can be an HTTP response message. The content manager component 212 detects a text/html MIME type indicator in an HTTP response header. As a result of the detection of the text/html MIME type, the content manager component 212 provides an HTML portion of the response to the text/html content handler component 214a for processing. Processing can include presentation of the web page via a widget controlled by a page/tab handler 332 of the presentation controller 316.

As discussed above, the map mark 408 can be used to indicate a content provider associated with a location on the map 402A being presented via the user interface 400A. Accordingly, for each map mark 408 representing a content provider, a presentation location on the map 402A can be determined and the map mark 408A can be presented on the map 402A. For example, the navigation space handler component 206 can be configured to determine a presentation location on the map 402A of a map mark 408 representing the content provider and present the map mark 408 on the map 402A.

In an aspect, a presentation location on the map 402A of a map mark 408 representing the content provider is determined based on at least one of user input, results of a search, location information received from a map information provider, a task being performed by a user, an attribute of the content, instructions received with the content, markup received with the content, and locations of content providers from which content was previously received. For example, the navigation space handler component 206 can be configured to determine a presentation location on the map 402A of a map mark 408 representing the content provider by determining the presentation location based on at least one of user input, results of a search, location information received from a map information provider, a task being performed by a user, an attribute of the content, instructions received with the content, markup received with the content, and locations of content providers from which content was previously received.

By way of example, the map 402A in the UI 400A is selected for presentation in a map widget 404A based on a user setting. The map 402A is configured as a “home map” for a user of the browser 306 or the “home map” of the browser 306. An input, such as a mouse click, is received in association with an address in a presentation space of a location on the presented map 402A. The map 402A depicts three map marks, ‘X’s, indicating locations associated with content providers. One ‘X’ is associated with flyover text widget 408 identifying the content provider as the United States Patent and Trademark Office (USPTO). The map marks can be presented as a result of a search where each map mark corresponds to an element in the search result set. The map marks can be presented as a result of input from the user, for example, indicating the content providers are to be map marked. A map mark is presented in association with a location and/or includes location information identifying a location on a map, where the content provider is associated with the location marked. The map marks can be provided by the map information provider. The map marks can be presented as a result of a configuration by a third party such as an administrator where the map marks are associated with a job or a task of the user. Map marks can be presented based on any attribute accessible to a browser and/or any entity with access to the browser and/or the map information. For example, the map marks can be presented as a result of an attribute of content from a content provider presented in a content widget, such the content window 410A. Presented content from a content provider can include instructions or markup indicating a map is to be presented in association with the presentation of the content. The content additionally or alternatively can indicate locations on a map to be marked for association with a service such as a content provider.

For example, in the UI 400A the map 402A is presented in a map widget 404A as a background much like a device desktop. Content from content providers is presented in a UI widget, such as a window and/or tab in front of the map, illustrated by the content window 410A. A content widget can be minimized to an icon, for example, resized, and/or can be maximized based on a detected event such as input received in association with an input control presented in a title bar 412 widget. A browser 306 can support a single window with a map background and/or can support presentation of multiple widgets each with a map background for presenting content over each map background. The browser 306 can provide a location bar 414 allowing a user to enter a URL or provide at least a portion of a geoaddress and/or a geospatial identifier of a location on the map 402 for identifying a content provider or for associating with an operation such as zooming to a region. A map can be manipulated via various input controls provided by the browser, such as a toolbar (not shown) control, and/or a menu item accessible via a menu bar 414.

In another example, the UI 400B illustrates a map 402B presented as a slide-out widget 404B. A browser 306 can be configured to associate a slide-out widget with each instance of the browser UI 400B. Alternatively, a browser can associate a slide-out widget with a content widget such as content window 410B, or a group of associated content widgets. Any number of events detected by the browser 306 can cause a sliding in and/or out of a slide-out widget. For example, an input selector within a specified distance of an edge of the content window 410B can be configured to indicate that the slide-out widget 404B is to be presented as sliding-out by the browser 306. Conversely, an input selector detected outside the specified distance can indicate the slide-out widget 404B is to be presented in an “in” position relative to the “out” position. An input associated with a portion of the content, such as a selection of a word or phrase, or the detection of a pointing device within a specified distance of a hyperlink object; can cause the browser 306 to present a map associated with and/or based on the selected content. Thus, the slide-out widget 404B would be slid out from the content window 410B in the user interface 400B.

Alternatively or additionally, the selection of a map to present can be associated with a change in stage of a workflow or a task. Similarly, a detected event can result in the removal of a presented map. Detected events can also affect the markings, active links, and other visual attributes of a map selected for presentation.

In the UI 400C, the map 402C is presented in a tab 404C, or alternatively a window or other widget, that is dedicated to map presentation by the browser 306. The map 402C selected and the map's presentable characteristics can be determined based on any attribute detectable by the browser 306. For example, in the UI 400C, in addition to the dedicated map tab widget 404C, tabs 410C1-3 are depicted associated with content providers providing content associated with the city, Seattle, in the tab 410C1; the coffee seller, Starbucks in the tab 410C2; and the online retailer, Amazon, in the tab 410C3. In an example, the navigation space handler component 206 can be configured to select a map for presenting in the map widget 404C based on a location of one or more content providers of the content in the active tabs.

A browser can be configured to provide the map 402C for navigation of active tabs. An active tab is a presented tab widget 410C selectable for viewing with content from a content provider. In UI 400C, the tab 410C1 labeled “Seattle”, the tab 410C2 labeled “Starbucks”, and the tab 410C3 labeled “Amazon” are active tabs. Based on the configuration, a page/tab handler 332 interoperates with the navigation space handler component 206 to determine locations on the map 402C for presenting indicators corresponding to the active tabs 410C1-3 managed by the page/tab handler 332. The presentation controller 316 receives the determined locations and instructs the GUI manager 320 to present a visual indicator for each active tab 410C1-3 as a location on the map 402C for selecting each tab. As can be appreciated, many user interface variations are possible.

A browser can be provided with blank maps that the user can populate with map marks analogous to current browsers that support a home page and bookmarks. A browser can be configured to dynamically determine at least a portion of content providers available in at least portion of the map and providing visual indicators for at least some of the services at locations associated with the services as described in above-identified U.S. application Ser. No. ______ (Attorney Docket No I527/US). Which services are determined, what region the determination is made for, and which of the determined content provider indicators are presented can depend on a variety of attributes available to a browser. For example, a browser can determine services based on a keyword, a query, an active task, a detected activity of another executable in the node 304, a presence status of a watched principal, and/or filter that is active. A region for which content providers are determined can depend on a user selection, a presentation state of a region, a zoom level of a region, a current stage in a workflow or task, a location of a user, and/or an active communication detected between the node 304 and a location of a second node participating in the communication. Which indicators to present for the determined content providers can depend on similar attributes such as a zoom level, a presentation state of a region, ranking criteria associated with a query, and/or an active task. Those skilled in the art will appreciate that the exemplary list of attributes above is not intended to be exhaustive and many other attributes can be employed. Alternatively or additionally, a browser can use a map to illustrate locations associated with currently displayed content as described above and/or can use a map to indicate locations of content providers accessed in the past. In each use of a map, a visual indicator associated with a location can be associated with input for indicating a content provider associated with a location associated with the visual indication on a map being presented via a user interface.

Input for indicating a content provider associated with an object included in the map can also be received, such as an office building, a store, a home, a statue or other work of art, a park, a low pressure system on a weather map, a congressional district on a political map, and the like. This provided list of objects in a map that can be associated with a content provider is not intended to be exhaustive. Since any object presented in a map has a location on the map identifiable by a geoaddress from a geoaddress space associated with the map, determining a geospatial identifier associated with the location can be performed using the systems and methods described herein.

A set of names can be pre-configured so that they are well-known to the browser 306, and/or a map provider. The well-known names can be assigned to identify a service or a category of information, for example. The browser 306 can receive an indication of a type of service or category of information from, for example, a user or based on an identified task. In response, to receiving input for indicating a content provider, a navigation space handler component 206 can receive associated input information as described above. The navigation space handler component 206 can be configured to determine a geospatial identifier based on or generated from at least a portion of a determined geoaddress associated with a location corresponding to a received input indication as described above. The navigation space handler component 206 can be further configured to generate the geospatial identifier based on a provided pre-configured name for indicating a category associated with a service. For example, a pre-configured name can be used to perform a lookup via a directory service, where the lookup request includes geospatial information identifying a region and a pre-configured name for identifying a provider of the category of service associated with the pre-configured name. In another example, a navigation space handler component 206 can be configure to generate a URL as described above and generate a URL path based on the pre-configured name for including in the URL, thus determining a geospatial identifier for a content provider associated with a location on a map corresponding to input received for indicating the content provider. Service identifiers used in DNS SRV records are discussed in RFC 2782.

It should be understood that the various system components (and means) defined by the claims and illustrated in the various block diagrams represent logical components that are configured to perform the functionality described herein. While at least one of these components are implemented at least partially as an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Moreover, the methods described herein can be embodied in executable instructions stored in a computer readable medium for use by or in connection with an instruction execution machine, apparatus, or device, such as a computer-based or processor-containing machine, apparatus, or device. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

The use of the terms “a” and “an” and “the” and similar referents in the context of describing the subject matter (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illuminate the subject matter and does not pose a limitation on the scope of the subject matter unless otherwise claimed. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for browsing using a geospatial map metaphor, the method comprising:
receiving input for indicating a content provider associated with a location on a map being presented via a user interface;
determining a geospatial identifier associated with the content provider associated with the location on the map;
determining a network address for the content provider based on the determined geospatial identifier;
requesting content from the content provider via the determined network address; and
receiving content from the content provider in response to the request,
wherein at least one of the preceding actions is performed on at least one electronic hardware component.

2. The method of claim 1 wherein receiving input for indicating a content provider associated with a location on a map being presented via a user interface includes presenting the map in a presentation space of a browser and receiving the input for indicating the content provider via the browser presentation space.

3. The method of claim 1 wherein receiving input for indicating a content provider associated with a location on a map being presented via a user interface includes receiving input indicating user selection of a presented map mark providing a visual indication of a content provider having a geospatial identifier associated with the location on the map.

4. The method of claim 1 wherein the map being presented via a user interface represents one of a geographic region, a man made structure, a man-made geospace, a virtual geographic region, a virtual structure, and a virtual geospace.

5. The method of claim 1 wherein determining a geospatial identifier associated with the content provider associated with the location on the map includes one of retrieving the geospatial identifier from a datastore associating geospatial identifiers with locations on the map and calculating the geospatial identifier from the location on the map.

6. The method of claim 1 wherein determining a geospatial identifier associated with the content provider associated with the location on the map includes determining a geoaddress based on the location on the map.

7. The method of claim 6 wherein determining a geospatial identifier associated with the content provider associated with the location on the map includes determining the geospatial identifier based on the geoaddress and metadata associated with the location on the map.

8. The method of claim 7 wherein the metadata indicates at least one of a service type associated with the content provider, at least a portion of a uniform resource indicator (URI) associated with the content provider, and a region of a geospace.

9. The method of claim 8 including determining the at least a portion of a URI indicated by the metadata based on at least one of a default value, a task that is being performed, the map, an active keyword associated with the map, a filter associated with the map, and a search specification associated with the map.

10. The method of claim 1 wherein determining a network address for the content provider based on the determined geospatial identifier includes determining one of an Internet protocol network address, a geospatial network address, a geospatial outside scope address, and a non-geospatial outside scope address.

11. The method of claim 1 wherein requesting content from the content provider via the determined network address and receiving content from the content provider in response to the request includes communicating with the content provider using a publish-subscribe protocol.

12. The method of claim 1 including determining a presentation location on the map of a map mark representing the content provider and presenting the map mark on the map.

13. The method of claim 12 wherein determining a presentation location on the map of a map mark representing the content provider includes determining the presentation location based on at least one of user input, results of a search, location information received from a map information provider, a task being performed by a user, an attribute of the content, instructions received with the content, markup received with the content, and locations of content providers from who content was previously received.

14. A system for browsing using a geospatial map metaphor, the system comprising:
means for receiving input for indicating a content provider associated with a location on a map being presented via a user interface;
means for determining a geospatial identifier associated with the content provider associated with the location on the map;
means for determining a network address for the content provider based on the determined geospatial identifier;
means for requesting content from the content provider via the determined network address; and
means for receiving content from the content provider in response to the request,
wherein at least one of the means includes at least one electronic hardware component.

15. A system for browsing using a geospatial map metaphor, the system comprising system components including:
an input router component configured to receive input for indicating a content provider associated with a location on a map being presented via a user interface;
a navigation space handler component configured to determine a geospatial identifier associated with the content provider associated with the location on the map;
a geospatial identifier resolver component configured to determine a network address for the content provider based on the determined geospatial identifier;
a content manager component configured to request content from the content provider via the determined network address; and
a content handler component configured to receive content from the content provider in response to the request,
wherein at least one of the system components includes at least one electronic hardware component.

16. The system of claim 15 comprising a browser including the input router component and a presentation controller component configured to present the map in a presentation space of a browser and receiving the input for indicating the content provider via the browser presentation space.

17. The system of claim 15 wherein the input router component is configured to receive input for indicating a content provider associated with a location on a map being presented via a user interface by receiving input indicating user selection of a presented map mark providing a visual indication of a content provider having a geospatial identifier associated with the location on the map.

18. The system of claim 15 wherein the map being presented via a user interface represents one of a geographic region, a man made structure, a man-made geospace, a virtual geographic region, a virtual structure, and a virtual geospace.

19. The system of claim 15 wherein the navigation space handler component is configured to determine a geospatial identifier associated with the content provider associated with the location on the map by one of retrieving the geospatial identifier from a datastore associating geospatial identifiers with locations on the map and calculating the geospatial identifier from the location on the map.

20. The system of claim 15 wherein the navigation space handler component is configured to determine a geospatial identifier associated with the content provider associated with the location on the map by determining a geoaddress based on the location on the map.

21. The system of claim 20 wherein the navigation space handler component is configured to determine a geospatial identifier associated with the content provider associated with the location on the map by determining the geospatial identifier based on the geoaddress and metadata associated with the location on the map.

22. The system of claim 21 wherein the metadata indicates at least one of a service type associated with the content provider, at least a portion of a URI associated with the content provider, and a region of a geospace.

23. The system of claim 22 wherein the at least a portion of a URI indicated by the metadata is determined based on at least one of a default value, a task that is being performed, the map, an active keyword associated with the map, a filter associated with the map, and a search specification associated with the map.

24. The system of claim 15 wherein the geospatial identifier resolver component is configured to determine a network address for the content provider based on the determined geospatial identifier by determining one of an Internet protocol network address, a geospatial network address, a geospatial outside scope address, and a non-geospatial outside scope address.

25. The system of claim 15 wherein the content manager component is configured to request content from the content provider via the determined network address using a publish-subscribe protocol and the content handler component is configured to receive content from the content provider in response to the request by using a publish-subscribe protocol.

26. The system of claim 15 wherein the navigation space handler component is configured to determine a presentation location on the map of a map mark representing the content provider and present the map mark on the map.

27. The system of claim 26 wherein the navigation space handler component is configured to determine a presentation location on the map of a map mark representing the content provider by determining the presentation location based on at least one of user input, results of a search, location information received from a map information provider, a task being performed by a user, an attribute of the content, instructions received with the content, markup received with the content, and locations of content providers from who content was previously received.

28. A computer readable medium storing a computer program, executable by a machine, for browsing using a geospatial map metaphor, the computer program comprising executable instructions for:
receiving input for indicating a content provider associated with a location on a map being presented via a user interface;
determining a geospatial identifier associated with the content provider associated with the location on the map;
determining a network address for the content provider based on the determined geospatial identifier;
requesting content from the content provider via the determined network address; and
receiving content from the content provider in response to the request.
